(19) United States
(12) Patent Application Publication
(10) Pub. No.: US 2005/0137966 A1
(43) Pub. Date: Jun. 23, 2005

(54) Flow control credit synchronization

(76) Inventors: Peter R. Munguia, Chandler, AZ (US); Gabriel R. Munguia, Phoenix, AZ (US)

Correspondence Address: INTEL CORPORATION, P.O. BOX 5326, SANTA CLARA, CA, 95056-5326, US

(21) Appl. No.: 10/742,376

(22) Filed: Dec. 19, 2003

(51) Int. Cl. G06F 17/60

(52) U.S. Cl. 705/38

(57) ABSTRACT

Machine-readable media, methods, and apparatus are described to maintain synchronization of redundant devices. In one embodiment, a transmitter sends data packets to a receiver via a primary channel. Further, the transmitter may throttle data packet transfers on the primary channel based upon credit limits associated with the primary channel and redundancy channels that couple the transmitter to redundant receivers.

### BACKGROUND

A computing environment may comprise redundant components to increase the reliability of services provided by the computing environment. Such high availability environments may include multiple platforms and/or components that operate synchronously or in a lockstep manner. As a result of having multiple platforms operating in a lockstep manner, a computing environment may continue to provide its services despite one of the platforms having a failure.

### BRIEF DESCRIPTION OF THE DRAWINGS

The invention described herein is illustrated by way of example and not by way of limitation in the accompanying figures. For simplicity and clarity of illustration, elements illustrated in the figures are not necessarily drawn to scale. For example, the dimensions of some elements may be exaggerated relative to other elements for clarity. Further, where considered appropriate, reference labels have been repeated among the figures to indicate corresponding or analogous elements.

FIG. 1 illustrates an embodiment of a computing environment having a redundancy group comprising two redundant devices.

FIG. 2 illustrates aspects of transmitters and receivers of the computing environment.

FIG. 3 illustrates an embodiment of a computing environment having a redundancy group comprising N redundant devices.

FIG. 4 illustrates an embodiment of a method of maintaining packet level synchronization between devices of a redundancy group.

### DETAILED DESCRIPTION

The following description describes techniques for synchronizing components and/or platforms. In the following description, numerous specific details such as logic implementations, opcodes, means to specify operands, resource partitioning/sharing/duplication implementations, types and interrelationships of system components, and logic partitioning/integration choices are set forth in order to provide a more thorough understanding of the present invention. It will be appreciated, however, by one skilled in the art that the invention may be practiced without such specific details. In other instances, control structures, gate level circuits and full software instruction sequences have not been shown in detail in order not to obscure the invention. Those of ordinary skill in the art, with the included descriptions, will be able to implement appropriate functionality without undue experimentation.

References in the specification to “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described.

Embodiments of the invention may be implemented in hardware, firmware, software, or any combination thereof. Embodiments of the invention may also be implemented as instructions stored on a machine-readable medium, which may be read and executed by one or more processors. A machine-readable medium may include any mechanism for storing or transmitting information in a form readable by a machine (e.g., a computing device). For example, a machine-readable medium may include read only memory (ROM); random access memory (RAM); magnetic disk storage media; optical storage media; flash memory devices; electrical, optical, acoustical or other forms of propagated signals (e.g., carrier waves, infrared signals, digital signals, etc.), and others. Further, firmware, software, routines, instructions may be described herein as performing certain actions. However, it should be appreciated that such descriptions are merely for convenience and that such actions in fact result from computing devices, processors, controllers, or other devices executing the firmware, software, routines, instructions, etc.

Similar components have been designated in the figures with reference numerals that differ in subscript only. When referring to similar components, the subscript may be dropped in the description to generally indicate the similar components. However, when referring to a specific component, its reference numeral with distinguishing subscript may be used to distinguish the component from other similar components.

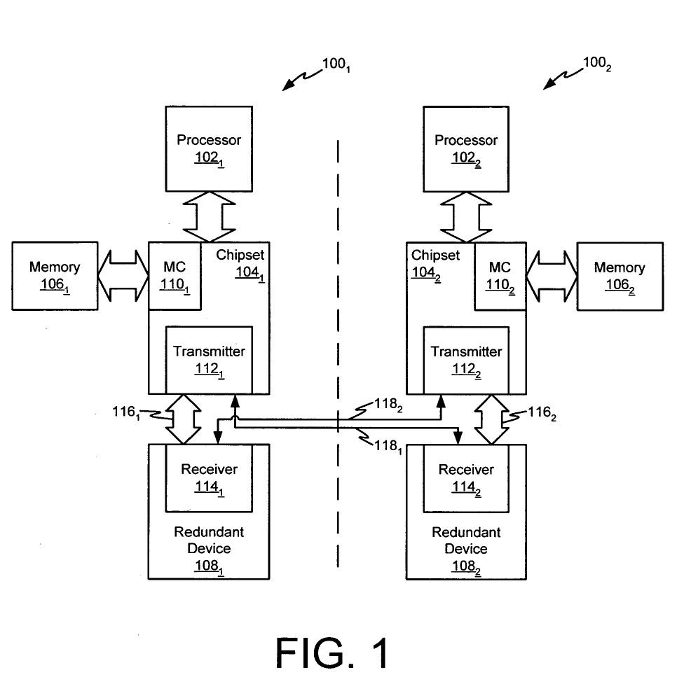

Now referring to FIG. 1, there is shown an embodiment of a computing environment comprising a first computing platform 100₁ and a second computing platform 100₂. The computing platforms 100 may operate in synchronization and/or in at least partial lockstep with one another. Further, each platform 100 may comprise a processor 102, a chipset 104, memory 106, and one or more redundant devices 108. The chipset 104 may include one or more integrated circuit packages or chips that couple the processor 102 to the memory 106 and the redundant device 108.

Each chipset 104 may comprise a memory controller 110 to read from and/or write data to memory 106 in response to read and write requests of a processor 102 and/or a redundant device 108. Each memory 106 may comprise one or more memory devices that provide addressable storage locations from which data may be read and/or to which data may be written. The memory 106 may also comprise one or more different types of memory devices such as, for example, DRAM (Dynamic Random Access Memory) devices, SDRAM (Synchronous DRAM) devices, DDR (Double Data Rate) SDRAM devices, or other volatile and/or non-volatile memory devices.

Each chipset 104 may further comprise a transmitter 112 to interface with receivers 114 of the redundant devices 108 of the first computing platform 100 and the second computing platform 100₂. In one embodiment, the transmitter 112₁ and the receiver 114₁ of the first platform 100₁ may establish a primary channel 116₁ for transfers of data packets and credit update packets therebetween. Further, the transmitter 112₁ may establish a redundancy channel 118₁ with a receiver 114₂ of the second computing platform 100₂ for transfers of credit update packets therebetween. Similarly, the transmitter 112₂ and the receiver 114₂ of the second platform 100₂ may establish a primary channel 116₂ for transfers of data packets and credit update packets therebetween. Further, the transmitter 112₂ may establish a redundancy channel 118₁ with a receiver 114₁ of the first computing platform 100₁ for transfers of credit update packets therebetween.

The redundant devices 108 may comprise storage devices, network devices, or other devices that operate in synchronization with or in lockstep with other redundant devices 108 of the same platform 100 or of another platform 100. In one embodiment, the transfer of data packets between the transmitter 112₁ and the receiver 114₁ of the first computing platform 100₁ across the primary channel 116₁ may be synchronized with the transfer of data packets between the transmitter 112₂ and the receiver 114₂ of the second computing platform 100₂ across the primary channel 116₂. To maintain synchronization, the transmitter 112₁ of the first computing platform 100₁ and the receiver 114₂ of the second computing platform 100₂ may transfer credit update packets across the redundancy channel 118₁. Similarly, the transmitter 112₂ of the second computing platform 100₂ and the receiver 114₁ of the first computing platform 100₁ may transfer credit update packets across the redundancy channel 118₂.

In one embodiment, the primary channel 116₁ of the first computing platform 100₁ may comprise eight (8) serial links to carry packets between the chipset 104₁ and the redundant device 108₁ of the first computing platform 100₁ in a manner similar to a ×8 PCI Express virtual channel. Further, each redundancy channel 118₁ of the first computing platform 100₁ may comprise one (1) serial link to carry credit update packets between the chipset 104₁ of the first computing platform 100₁ and the redundant device 108₂ of the second computing platform 100₂ in a manner similar to a ×1 PCI Express virtual channel. However, the primary channel 116₁ and the redundancy channel 118₁ of the first computing platform 100₁ in other embodiments may comprise different channel types and/or channel widths.

Similarly, the primary channel 116₂ of the second computing platform 100₁ may comprise eight (8) serial links to carry packets between the chipset 104₂ and the redundant device 108₂ of the second computing platform 100₁ in a manner similar to a ×8 PCI Express virtual channel. Further, each redundancy channel 118₂ of the second computing platform 100₂ may comprise one (1) serial link to carry credit update packets between the chipset 104₂ of the second computing platform 100₂ and the redundant device 108₁ of the first computing platform 100₁ in a manner similar to a ×1 PCI Express virtual channel. However, the primary channel 116₂ and the redundancy channel 118₂ of the second computing platform 100₂ in other embodiments may comprise different channel types and/or channel widths.

Further, the links of the primary channels 116 may use different mediums than the links of the redundancy channels 118 and may be shorter in length than the links of the redundancy channels 118. For example, the primary channels 116 may comprise conductive links to transmit electrical signals between a chipset 104 and a device 108 of the same computing platform 100. The redundancy channels 118 on the other hand may comprise fiber links to transmit optical signals between a first computing platform 100₁ and a second computing platform 100₂ which may be in the same room as the first computing platform 100₁, a different room than the first computing platform 100₁, or in a different geographic location (e.g. city, state, country) than the first computing platform 100₁. Due to the differences in the medium, lengths, and/or widths of the primary channels 116 and the redundancy channels, the redundancy channels 118 may have a substantially longer transfer delay than the primary channels 116.

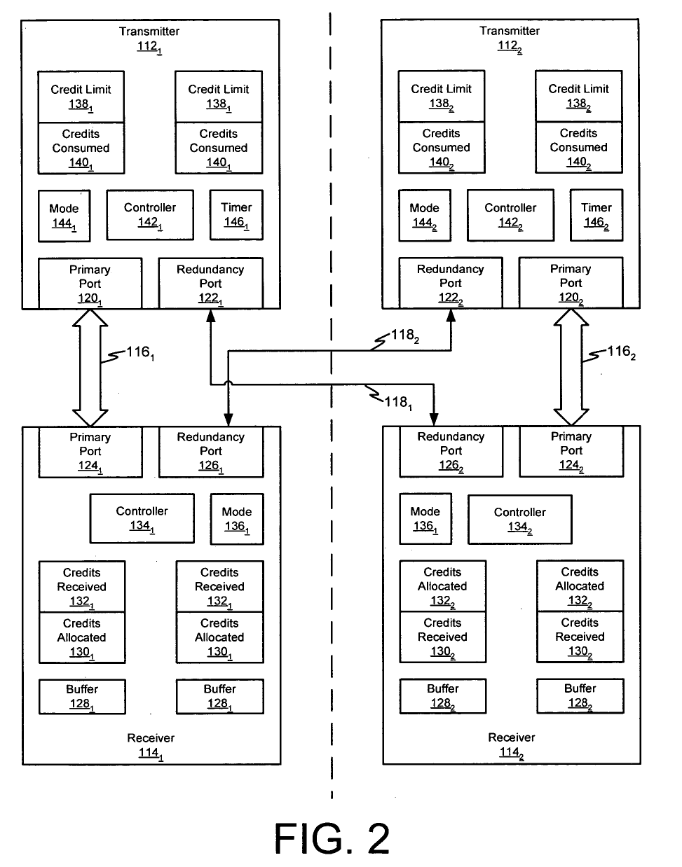

Referring now to FIG. 2, aspects of the transmitters 112 and the receivers 114 are depicted in further detail. As depicted, each transmitter 112 may comprise a primary port 120 and one or more redundancy ports 122 for the primary port 120. Similarly, each receiver 114 may comprise a primary port 124 and one or more redundancy ports 126 for the primary port 124. In one embodiment, the primary ports 120, 124 may establish primary channels 116 via which data packets, credit update packets, and other packets may be transferred. Further, the redundancy ports 122, 126 may establish redundancy channels 118 via which credit update packets may be transferred.

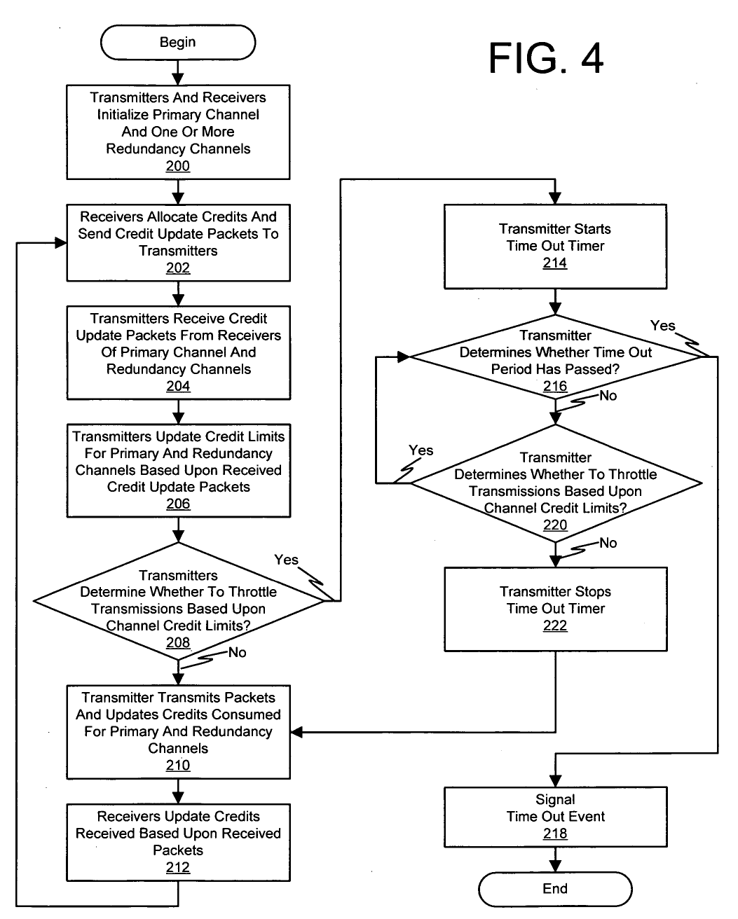

In one embodiment, a receiver 114 may send credit update packets to the transmitters 112 to provide the transmitters 112 with information about the size of its buffer 128 and/or space available in its buffer 128. As a result of supplying this information, the transmitters 112 may maintain an estimate of the available buffer space, and may proactively throttle its transmission if it determines that transmission might cause an overflow condition in the receive buffer 128. Further, as will be explained in detail in regard to FIG. 4 below, a transmitter 112 may further throttle its transmissions to the receivers 114 in response to an imbalance in credits between its primary channel 116 and one or more redundancy channels 118. By throttling such transmissions based upon credit imbalances, the transmitter 112 may maintain synchronization of its primary channel 116 with the primary channel 116 of another transmitter 112.

As depicted, the receiver 114 may comprise a separate buffer 128 and a separate credits allocated register 130 for the primary channel 116 and each redundancy channel 118. Each credits allocated register 130 may store a credits allocated value that indicates a total number of credits that the receiver 114 has allocated to a channel 116, 118 since channel initialization. The receiver 114 may initially set the credits allocated value of the credits allocated registers 130 according to the size of the corresponding buffer 128. The receiver 114 may later allocate credits to a channel 116, 118 based upon various allocation policies and may update the credits allocated values accordingly. In one embodiment, each credits allocated register 130 may comprise 8-bits and may store the credits allocated value using modulo arithmetic wherein the credits allocated value is kept between 0 and a register limit (e.g. 255 for an 8-bit register) by effectively repeatedly adding or subtracting the register limit until the result is within range. However, it should be appreciated that the receiver 114 may reach the same mathematical result via other mechanisms such as implementing each credits allocated register 130 as an 8-bit rollover counter.

In one embodiment, the receiver 114 may further comprise a separate credits received register 132 for the primary channel 116 and each of its redundancy channels 118. Each credits received register 132 may store a credits received value that indicates a total number of credits via the channel 116,118 since channel initialization. The receiver 114 may initially set the credits received values to zero in response to channel initialization. In one embodiment, each credits received register 132 may comprise 8-bits and may store the credits received value using modulo arithmetic wherein the credits allocated value is kept between 0 and a register limit (e.g. 256).

The receiver 114 may further comprise a controller 134 and a mode register 136 that may be updated to indicate which channels 116,118 are part of a redundancy group. The controller 134 may allocate the same number of credits to each channel 116, 118 of a redundancy group and may update the respective credits allocated registers 130 accordingly. The controller 134 may further send credit update packets to the transmitters 112 coupled to the channels 116, 118 of the redundancy group to provide each of the transmitters 112 of the redundancy group with a credit limit.

Each transmitter 112 may comprise a separate credit limit register 138 and a separate credits consumed register 140 for each channel 116, 118 of a redundancy group. Each credits consumed register 140 may store a credits consumed value that indicates the total number of credits of the associated channel 116, 118 that the transmitter 112 has consumed since channel initialization. Upon channel initialization (e.g., start-up, reset, etc.), each credits consumed register 140 may be set to zero, and may be subsequently updated to reflect the number of credits of the associated channel 116, 118 that the transmitter 112 has consumed. In one embodiment, each credits consumed register 140 may comprise 8-bits and may store the credits consumed value using modulo arithmetic wherein the credits consumed register 140 is kept between 0 and a register limit (e.g. 255).

Each credit limit register 138 may store a credit limit that indicates a maximum number of credits of the associated channel 116, 118 that the transmitter 112 may consume. Upon channel initialization (e.g., start-up, reset, etc.), each credit limit register 138 may be set to zero, and may be subsequently updated to reflect a credit limit received from a receiver 114 via a credit update packet. The credit limit register 138 like the credits consumed register 140 may also comprise 8-bits and may store the credit limit using modulo arithmetic.

Each transmitter 112 may further comprise a controller 142 and a mode register 144 that may be updated to indicate which channels 116, 118 are part of a redundancy group. The controller 142 may determine to throttle a channel 116, 118 based upon the credits consumed value of its associated credits consumed register 140 and the credit limit of its associated credit limit register 138. In one embodiment, the receiver 114 may allocate no more than half of the register limit (e.g. 128) of unused credits to a transmitter 112. As a result, the controller 142 may throttle or stop further transmission on channel 116, 118 in response to determining that further transmissions would result in the updated credits consumed value for the channel 116, 118 to exceed the credit limit for the channel 116, 118 in modulo arithmetic. In particular, the controller 142 may determine to throttle transmissions on a channel 116, 118 in response to determining that the following equation is not satisfied:
(CREDIT_LIMIT−UPDATED_CREDITS_CONSUMED) mod REG_RANGE_LIMIT<=(REG_RANGE_LIMIT/2),
where CREDIT_LIMIT corresponds to the credit limit of the credit limit register 138 for the channel, UPDATED_CREDITS_CONSUMED corresponds to the updated credits consumed value for the channel, and REG_RANGE_LIMIT corresponds to register limit (e.g. 256) of the credit limit register 138 or the credits consumed register 140 for the channel.

The controller 142 may further determine to throttle the primary channel 116 in response to an imbalance in the credit limits of the channels 116, 118 of the redundancy group indicating that the transmitter 112 is ahead of another transmitter 112 of the redundancy group. In one embodiment, the controller 142 may throttle or stop sending further data packets on the primary channel 116 in response to any credit limit of the associated redundancy channels 118 being less than the credit limit of the primary channel 116. In this manner, the controller 142 may maintain a level of synchronization between the transmitter 112 and other transmitters 112 of the redundancy group.

Further, each transmitter 112 may comprise a timer 146. In one embodiment, the transmitter 112 may reset the timer 146 to a specified value that results in the timer 146 indicating a time out event after a specified period has elapsed. In particular, the transmitter 112 may utilize the timer 146 to limit how long the transmitter 112 may throttle the primary channel 116.

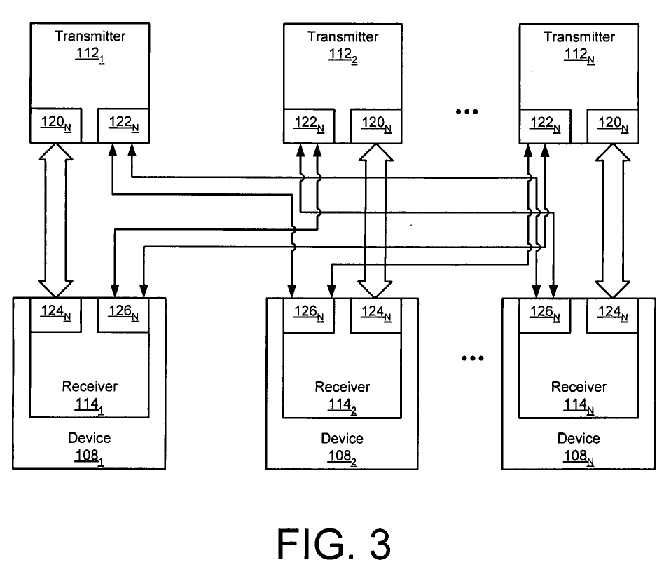

As shown in FIG. 3, a redundancy group of a computing environment may comprise more than two redundant devices 108. Further, the redundant devices 108 may all be part of a single computing platform or may span many computing platforms. In an environment having N redundant devices 108₁ . . . 108_{N}, each transmitter 112 may comprise a primary port 120 to transmit data packets and credit update packets with a receiver 114 coupled to the primary port 120. Further, each transmitter 112 may comprise N-1 redundancy ports 122 to transmit credit update packets with the N-1 receivers 114 coupled to the N-1 redundancy ports 122. For example, in a computing environment having four (4) redundant devices 108₁ . . . 108₄, a transmitter 112₁ may comprise a primary port 120₁ to establish a primary channel with a primary port 124₁ of a redundant device 108₁. Further, the transmitter 112₁ may comprise three (3) redundancy ports 122₁ to establish three (3) redundancy channels with the redundancy ports 126₂, 126₃, 126₄ of the devices 108₂, 108₃, 108₄.

Referring now to FIG. 4, there is shown a method of maintaining packet level synchronization of redundant devices 108. In block 200, the transmitters 112 and receivers 114 may initialize channels for synchronous transfers. In one embodiment, the processor 102 in response to executing operating system and/or device driver routines may update the mode store 144 of each transmitter 112 to indicate which channels 116, 118 are part a redundancy group. Similarly, the processor 102 may update the mode store 136 of each receiver 112 to indicate which channels 116, 118 are part of the redundancy group. Further, each transmitter 112 may clear the credits consumed registers 140 and the credit limit registers 138 associated with the channels 116, 118 of the redundancy group. Each receiver 114 may also clear the credits allocated register 130 and the credits received register 132 associated with the channels 116, 118 of the redundancy group.

Each receiver 114 of the redundancy group in block 202 may allocate the same number of credits to each channel 116, 118 of the redundancy group. Each receiver 114 may then update its credits allocated registers 130₁ associated with each channel 116, 118 to reflect the number of credits allocated to the channel 116, 118. In a particular, each receiver 114 may increment its credits allocated registers 130₂ by the allocated number of credits. Further, each receiver 114 may transmit credit update packets to the transmitters 112 via the channels 116, 118 of the redundancy group to provide the transmitters 112 with an updated credit limit that is indicative of the total credits allocated to the channel 116, 118.

In block 204, each transmitter 112 may receive credit update packets from the receivers 114 via the channels 116, 118 of the redundancy group as defined by the mode store 144. In response to receiving a credit update packet via a channel 116, 118, each transmitter 112 in block 206 may update the credit limit associated with the channel 116, 118 via which the credit update packet was received. In one embodiment, each transmitter 112 may update the credit limit by storing in the credit limit register 138 associated with the channel 116, 118 the credit limit supplied by the received credit update packet.

Each transmitter 112 in block 208 may determine whether to transmit a data packet via their primary channel 116. In one embodiment, a transmitter 112 may determine to transmit a data packet to the receiver 114 via its primary channel 116 in response to determining (i) that the primary channel 116 has enough credits to transfer the data packet and (ii) that the credit limit of the primary channel 116 is not greater than the credit limit of any redundancy channel 118 of the redundancy group. To this end, the transmitter 112 may obtain an updated credits consumed value by adding the number of credits required to transmit the data packet to the credits consumed value of the credits consumed register 140 for the primary channel 116. Further, the transmitter 112 may determine based upon the updated credits consumed value and the credit limit of the primary channel credit limit register 138 whether transmitting the packet would exceed the credits allocated to the primary channel 116. In one embodiment, the transmitter 112 may determine that the primary channel 116 has enough credits to transfer the data packet in response to determining that
(CREDIT_LIMIT−UPDATED_CREDITS_CONSUMED) mod REG_RANGE_LIMIT<=(REG_RANGE_LIMIT/2).

In response to determining to transmit the data packet, the transmitter 112 in block 210 may update the credits consumed registers 140 for each channel 116, 118 and may transmit packets to the receivers 114 via the channels 116, 118 of the redundancy group. In one embodiment, a transmitter 112 may increment its credits consumed register 140 for each of the channels 116, 118 by the credits required to transmit the data packet modulo the register limit of the credits consumed register 140. Further, the transmitter 112 may transmit the data packet via the primary channel 116 and may transmit a credit update packet via each of the redundancy channels 118 that indicates the number of credits consumed by transmitting the data packet on the primary channel 116.

In response to receiving packets from the transmitters 112, the receivers 114 in block 212 may update their credits received registers 132 based upon the received packet. In one embodiment, in response to receiving a data packet via the primary channel 116, a receiver 114 may increment its primary channel credits received register 132 by the credits consumed by the received data packet modulo the register limit (e.g. 256) of the credits received register 132. Further, in response to receiving a credit update packet via a redundancy channel 118, a receiver 114 may increment the credits received register 132 of the corresponding redundancy channel 118 by the credits indicated by the received credit update packet modulo the register limit (e.g. 256) of the credits received register 132. The receivers 114 may then return to block 202 to allocate further credits to the transmitters 112.

The transmitters 112 may continue to send data packets via the primary channels 116 in block 210 until a transmitter 112 in block 208 determines to throttle further transmissions due to its primary channel 116 not having enough credits to transmit a data packet via the primary channel 116 or the credit limit registers 138 indicating that the transmitter 112 is ahead of other transmitters 112 in the redundancy group. In response to determining to throttle transmissions, the transmitter 112 in block 214 may start the timer 146. In particular, the transmitter 112 in one embodiment may reset the timer 146 to a specified value that causes the timer 146 to indicate a time out event after a specified period has elapsed.

The transmitter 112 may then determine in block 216 whether a time out event has occurred based upon the status of the timer 146. In response to determining that a time out event has occurred, the transmitter 112 may signal in block 218 the occurrence of the time out event so that corrective action may be taken. In particular, the transmitter 112 in one embodiment may generate an interrupt that requests a service routine of a device driver or an operating system to handle the time out event. For example, the service routine may determine that the time out event is due to a failed device 108 and may perform various corrective actions such as, for example, removing the failed device 108 from the redundancy group of the transmitters 112 and receivers 114 so that the remaining transmitters 112 and receivers 114 may continue transferring packets.

However, in response to determining that a time out event has not occurred, the transmitter 112 in block 220 may determine whether to continue throttling data packet transfers on the primary channel 116. In one embodiment, a transmitter 112 may determine to stop throttling the primary channel 116 in response to determining (i) that the primary channel 116 has enough credits to transfer the data packet and (ii) that the credit limit of the primary channel 116 is not greater than the credit limit of any redundancy channel 118 of the redundancy group. The transmitter 112 may continue to determine whether a time out event has occurred (block 222) or whether to continue throttling the primary channel 116 (block 224) until either a time out event occurs or the transmitter 112 determines that it may stop throttling the primary channel 116. Once the transmitter 112 determines to stop throttling, the transmitter 112 in block 226 may stop the time out timer 146. Further, the transmitter 112 may continue to block 210 to transmit data packets via its primary channel 116.

It should be appreciated that while the transmitter 112 is throttling the primary channel 116 the receiver 114 coupled to the primary channel 116 may issue the transmitter 112 more credits thus possibly providing the transmitter 112 with enough credits to transfer a data packet on the primary channel 116. Further, one or more receivers 114 coupled to redundancy channels 118 of the transmitter 112 may also allocate more credits to the redundancy channels 118, thus resulting in the credit limit for the primary channel 116 being less than or equal to each credit limit of the redundancy channels 118. Either of these two situations may result in the transmitter 112 resuming transmissions on the primary channel 116. For example, if the transmitter 112₁ of the first computing platform 100₁ was ahead of the transmitter 112₂ of the second computing platform 100₂, the transmitter 112₁ may continue to throttle its primary channel 116₁ until the transmitter 112₂ of the second computing platform 100₂ caught up and a receiver 114₂ of the second computing platform 100₂ sent a credit update packet via a redundancy channel 118₁. Accordingly, the receivers 114 may keep primary channels 116 in packet level synchronization by refusing to allocate additional credits until previously allocated credits are consumed.

Certain features of the invention have been described with reference to example embodiments. However, the description is not intended to be construed in a limiting sense. Various modifications of the example embodiments, as well as other embodiments of the invention, which are apparent to persons skilled in the art to which the invention pertains are deemed to lie within the spirit and scope of the invention.

1. A method comprising
receiving a credit limit for a primary channel,
receiving a credit limit for a redundancy channel, and
throttling data packet transfers on the primary channel based upon the credit limit of the primary channel and the credit limit of the redundancy channel.

2. The method of claim 1,wherein throttling comprises determining whether to transfer a data packet on the primary channel based upon the credit limit of the primary channel and the credit limit of the redundancy channel.

3. The method of claim 1 wherein throttling comprises determining to transfer a data packet on the primary channel in response to the credit limit of the primary channel being equal to the credit limit of the redundancy channel.

4. The method of claim 1 wherein throttling comprises determining to transfer no data packets on the primary channel in response to the credit limit of the primary channel being greater than the credit limit of the redundancy channel.

5. The method of claim 1 further comprising generating a time out event in response to determining to transfer no data packets on the primary channel for a specified period of time.

6. The method of claim 1 further comprising
transferring a data packet on the primary channel that consumes a number of credits in response to the throttling determining to transfer a data packet on the primary channel, and
transferring a credit update packet on the redundancy channel that indicates the number of credits consumed by the data packet on the primary channel.

7. The method of claim 1 further comprising receiving a credit limit for another redundancy channel, wherein throttling data packet transfers on the primary channel is further based upon the credit limit of the another redundancy channel.

8. The method of claim 7 further comprising
transferring a data packet on the primary channel that consumes a number of credits in response to the throttling determining to transfer a data packet on the primary channel,
transferring a credit update packet on the redundancy channel that indicates the number of credits consumed by the data packet on the primary channel, and
transferring a credit update packet on the another redundancy channel that indicates the number of credits consumed by the data packet on the primary channel.

9. A method comprising
allocating each channel of a redundancy group of channels a same number of credits, and
updating a credits allocated value for each channel to account for the same number of credits allocated to each channel.

10. The method of claim 9 further comprising transmitting a packet on each channel that comprises a credit limit that is indicative of the same number of credits allocated to each channel.

11. The method of claim 9 further comprising receiving an indication as to which channels of a plurality of channels comprise the redundancy group of channels.

12. The method of claim 9 further comprising
transmitting a packet on a primary channel of the redundancy group of channels that comprises the credit limit that is indicative of the same number of credits allocated to each channel, and
transmitting a packet on a redundancy channel of the redundancy group of channels that comprises the credit limit that is indicative of the same number of credits allocated to each channel.

13. A device comprising
a credit limit register to indicate a credit limit for a primary channel,
a credit limit register to indicate a credit limit for a redundancy channel, and
a controller to throttle data packet transfers on the primary channel based upon the credit limit for the primary channel and the credit limit for the redundancy channel.

14. The device of claim 13 wherein the controller determines to transfer a data packet on the primary channel in response to the credit limit of the primary channel being equal to the credit limit of the redundancy channel.

15. The device of claim 13 wherein the controller determines to transfer no data packets on the primary channel in response to the credit limit of the primary channel being greater than the credit limit of the redundancy channel.

16. The device of claim 13 further comprising
a timer to indicate a time out event after a specified period has elapsed since the timer was started, wherein
the controller starts the timer in response to determining to transfer no data packets on the primary channel.

17. The device of claim 13 wherein the controller determines to transfer a data packet on the primary channel that consumes a number of credits in response to the throttling determining to transfer a data packet on the primary channel, and transfer a credit update packet on the redundancy channel that indicates the number of credits consumed by the data packet on the primary channel.

18. The device of claim 13 further comprising
a credits consumed register to indicate a credits consumed value for the primary channel, and
a credits consumed register to indicate a credits consumed value for the redundancy channel, wherein
the controller determines updates the credits consumed register for the primary channel to account for the number of credits consumed by the data packet and updates the credits consumed register for the redundancy channel to account for the number of credits consumed by the data packet.

19. The device of claim 13 further comprising a register to indicate identify the primary channel and the redundancy channel as part of a redundancy group of channels.

20. The device of claim 13 further comprising
a redundancy port for the redundancy channel, and
a primary port for the primary channel, wherein the primary channel includes more links than the redundancy channel.

21. A device comprising
a credits allocated register to indicate a credits allocated value for a primary channel,
a credits allocated register to indicate a credits allocated value for a redundancy channel, and
a controller to allocate the primary channel a number of credits and to allocate the redundancy channel the same number of credits as allocated to the primary channel.

22. The device of claim 21 wherein the controller further transmits on the primary channel a packet that comprises a credit limit that is indicative of the credit allocated value for the primary channel, and transmits on the redundancy channel a packet that comprises a credit limit that is indicative of the credit allocate value for the redundancy channel.

23. The device of claim 21 further comprising a register to indicate that the primary channel and the redundancy channel are part of a redundancy group of channels.

24. The device of claim 21 further comprising
a redundancy port for the redundancy channel, and
a primary port for the primary channel, wherein the primary channel includes more links than the redundancy channel.

25. A system comprising
a first transmitter comprising a primary port and a redundancy port,
a second transmitter comprising a primary port and a redundancy port,
a first receiver comprising a primary port to establish a first primary channel with the primary port of the first transmitter and a redundancy port to establish a first redundancy channel with the redundancy port of the second transmitter, the first receiver allocating a number of credits to the first primary channel and the first redundancy channel, sending a credit update packet on the first primary channel that comprises a credit limit indicative of the number of credits allocated to the first primary channel, and sending a credit update packet on the first redundancy channel that comprises a credit limit indicative of the number of credits allocated to the first primary channel, and
a second receiver comprising a primary port to establish a second primary channel with the primary port of the second receiver and a redundancy port to establish a second redundancy channel with the redundancy port of the first transmitter, the second receiver allocating the same number of credits to the second primary channel and the second redundancy channel as the first receiver allocated to the first primary channel and the first redundancy channel, sending a credit update packet on the second primary channel that comprises a credit limit indicative of the number of credits allocated to the second primary channel, and sending a credit update packet on the second redundancy channel that comprises a credit limit indicative of the number of credits allocated to the second redundancy channel.

26. The system of claim 25 wherein the first transmitter determines whether to transfer a packet to the first receiver based upon the credit limit received from the first receiver and the credit limit received from the second receiver.

27. The system of claim 25 wherein the first transmitter further comprises another redundancy port and the system further comprises
a third receiver comprising a redundancy port to establish a third redundancy channel with the another redundancy port of the first transmitter, the third receiver allocating the same number of credits to the third redundancy channel as the first receiver allocated to the first primary channel and the first redundancy channel, and sending a credit update packet on the third redundancy channel that comprises a credit limit indicative of the number of credits allocated to the third redundancy channel.

28. The system of claim 25 wherein the primary channels each include more links than the redundancy channels.

29. The system of claim 25 wherein the first primary channel and the first redundancy channel have substantially different transfer delays across the channels.
